(19) United States
(12) Patent Application Publication
(10) Pub. No.: US 2025/0306216 A1
(43) Pub. Date: Oct. 2, 2025

(54) ASSISTED L5-ONLY GNSS RECEIVER WITH INTEGRATED L1 GNSS SUPPORT

(71) Applicant: SONY GROUP CORPORATION, TOKYO (JP)

(72) Inventor: JIGNESH DOSHI, CARLSBAD, CA (US)

(21) Appl. No.: 19/034,666

(22) Filed: Jan. 23, 2025

Related U.S. Application Data
(60) Provisional application No. 63/572,106, filed on Mar. 29, 2024.

(51) Int. Cl. G01S 19/32; G01S 19/37

(52) U.S. Cl. CPC G01S 19/32; G01S 19/37

(57) ABSTRACT

Provided is a system and method for assisting external and standalone L5-only GNSS receiver with integrated/internal L1-GNSS support (on modem System-on-Chip (SoC)). The system includes modem SoC including an L1-GNSS (Global Navigation Satellite System) receiver that supports an L1 frequency band and an L5-GNSS receiver that supports an L5 frequency band. The L1-GNSS receiver acquires L1-GNSS signals from satellites of at least one satellite constellation. The L1-GNSS receiver further executes an L1-acquisition operation based on the acquired L1-GNSS signals to generate assistance information. The L5-GNSS receiver acquires the generated assistance information from the L1-GNSS receiver. The L5-GNSS receiver further executes an L5-acquisition and tracking operation for the satellites based on the assistance information.

### CROSS-REFERENCE TO RELATED APPLICATIONS/INCORPORATION BY REFERENCE

This application claims priority to U.S. Provisional Patent Application Ser. No. 63/572,106 filed on Mar. 29, 2024, the entire content of which is hereby incorporated herein by reference.

### FIELD

Various embodiments of the disclosure relate to satellite-based navigation. More specifically, various embodiments of the disclosure relate to an assisted L5-only GNSS receiver with integrated L1 GNSS support.

### BACKGROUND

A satellite-based navigation system consists of satellites orbiting the Earth, ground-based control stations, and receivers. The system' purpose is to provide accurate positioning, navigation, and timing information globally. The system may typically operate by using a constellation of satellites that transmit signals containing precise timing information and orbital parameters. These signals may be continuously broadcasted and received by ground receivers. To determine their position, the receivers may receive signals from multiple satellites simultaneously. By measuring the time it takes for the signals to travel, the receiver may calculate the distance between itself and each satellite, considering the known positions of the satellites and the signal travel time. This information may be then used to calculate the receiver's precise position, velocity, and time. However, it's important to note that factors like signal blockage, atmospheric conditions, and receiver limitations can affect the accuracy and availability of satellite-based navigation systems. Different types of receivers, such as L1-band, L2-band, and L5-band based GNSS receivers, may be used to receive GNSS signals from the satellite-based navigation system. The discreet standalone L5-only GNSS receivers have lower sensitivity, higher TTFF (Time to First Fix), and higher acquisition time and power consumption. Therefore, developing L5-only receivers as viable commercial solutions is technically and commercially challenging. Conventionally, the issues may be solved using multi-band (L1+L5, L2+L5, L1+L2+L5) and multi-constellation GNSS receivers. However, these multiband GNSS receivers may be larger, costlier, and may consume more power.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and a method for assistance of L5-only GNSS with the support of integrated L1-GNSS receiver, is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram that illustrates an exemplary network environment for L5-GNSS receiver assistance with the support of integrated L1-GNSS receiver, in accordance with an embodiment of the disclosure.

FIG. 2 is a block diagram of L1-GNSS receiver of FIG. 1, in accordance with an embodiment of the disclosure.

FIG. 3 is a block diagram of L5-GNSS receiver of FIG. 1, in accordance with an embodiment of the disclosure.

FIG. 4 is an exemplary block diagram that illustrates the system that includes the L1-GNSS receiver of FIG. 2 and the L5-GNSS receiver of FIG. 3, in accordance with an embodiment of the disclosure.

FIG. 5 is an exemplary block diagram that illustrates a chipset for L5-GNSS receiver assistance with the support of integrated L1-GNSS receiver, in accordance with an embodiment of the disclosure.

FIG. 6 is a flowchart that illustrates an exemplary method for L5-GNSS receiver assistance with the support of integrated L1-GNSS receiver, in accordance with an embodiment of the disclosure.

### DETAILED DESCRIPTION

The following described implementations pertain to a system and method for external and standalone L5-only GNSS receiver assistance with the support of an integrated L1-GNSS receiver. The system may include an L1-Global Navigation Satellite System (L1-GNSS) receiver that supports the L1 frequency band. The L1-GNSS receiver may be integrated within a modem associated with the system. The L1-GNSS receiver may be configured to acquire L1-GNSS signals from satellites of at least one satellite constellation. The L1-GNSS receiver may further be configured to execute an L1-acquisition operation based on the acquired L1-GNSS signals to generate assistance information. Additionally, the system may include an L5-GNSS receiver that supports the L5 frequency band. The L5-GNSS receiver may acquire the generated assistance information from the integrated/internal L1-GNSS receiver and execute an L5-acquisition and tracking operation for tracking and retracking the satellites based on the assistance information. This makes the system smaller, more efficient, cost-effective, and may consume less power.

Typically, a conventional L1-band based GNSS receiver relies solely on the signals transmitted by satellites on the L1 frequency. In certain situations, such as in urban canyons or dense foliage, the signals may be obstructed or weakened, leading to reduced signal availability and degraded performance. Moreover, the L1-band based GNSS receiver relies on signals from a limited number of satellites in view at any given time. This may result in reduced accuracy and availability, especially in areas with obstructed views of the sky or during periods of low satellite visibility. Furthermore, switching from the L1-band based GNSS receiver to the L5-band based GNSS receiver has become necessary to adhere to various rules and regulations established by major entities.

Currently, L5-GNSS signals are available only from a limited number of satellite navigation systems, such as the Global Positioning System (GPS) and the Galileo system, which results in limited accessibility of the L5-GNSS signals. The L5-band based receiver is generally more expensive compared to receivers that only support L1 band or L2 band. Additionally, the L5-band based receiver typically requires more power to operate compared to receivers that only use lower frequency bands, such as the L1-band based receiver. This may deteriorate the life of the electric power source associated with the system. Moreover, due to high power consumption, more frequent recharging of the electric power source may be required, and the charge-holding capacity of the electric power source may also need to be increased.

To address these issues, the proposed system makes use of the integrated/internal L1-GNSS receiver that is typically found on most wireless connectivity modem devices. The modem may include an L1-Global Navigation Satellite System (L1-GNSS) receiver that supports the L1 frequency band. The L1-GNSS receiver may be configured to acquire L1-GNSS signals from satellites of at least one satellite constellation, such as GPS or Galileo. The L1-GNSS receiver may further be configured to execute an L1-acquisition operation based on the acquired L1-GNSS signals to generate assistance information. The system may also include an external and standalone L5-GNSS receiver that supports the L5 frequency band. The L5-GNSS receiver may acquire the generated assistance information from the L1-GNSS receiver and execute an L5-acquisition and tracking operation for the satellites based on the assistance information generated by the integrated/internal L1-GNSS receiver. The L5-acquisition and tracking operation may include tracking and retracking of the satellites and establishing a synchronized communication channel between the L5-GNSS receiver and the satellites. The initial acquisition of L1-GNSS signals through the modem integrated/internal L1-GNSS receiver, and the subsequent generation of assistance information for the functioning of the external and standalone L5-GNSS receiver, makes the system more efficient, cost-effective, and power-saving.

The disclosed system may offer several advantages, including achieving dual-band level performance using a combination of GNSS service providers (such as GPS+GAL L5-only) on connected devices with modems (such as LTE modem). The system may ensure that the cold start sensitivity of L5-only receiver is equal to dual-band. The system achieves lower Time to First Fix (TTFF) and sensitivity on L5-only without enabling non-GPS receivers (such as BeiDou), while maintaining similar L1 spoofing and jamming tolerance during L5-only tracking. The system may ensure LTE+GNSS concurrency with unnoticeable interruptions to the end user's connectivity, as LTE is only interrupted occasionally and for short periods, typically a few seconds, for quick L1 acquisition and reacquisitions on the modem.

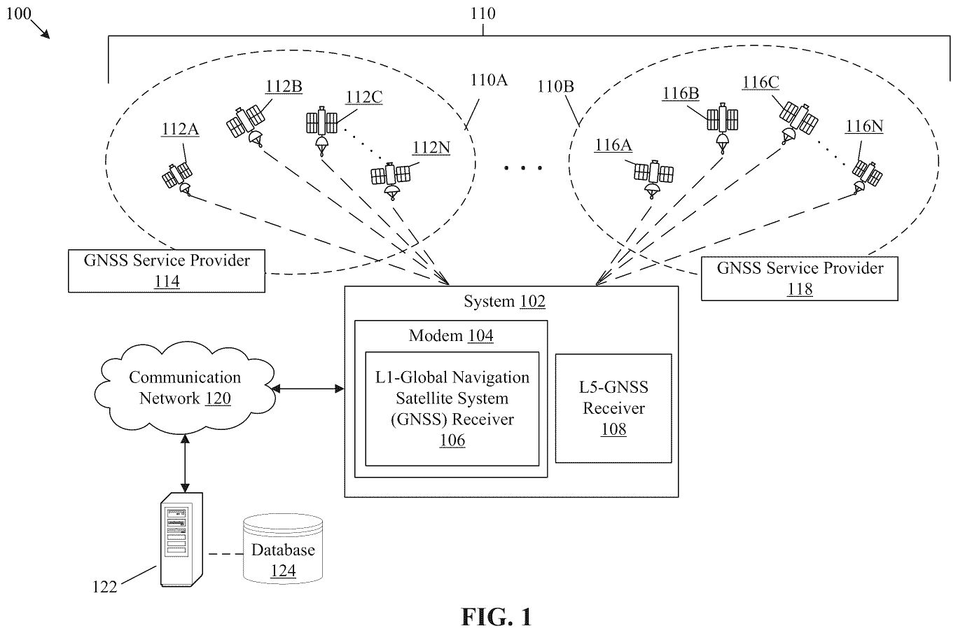

FIG. 1 is a diagram that illustrates an exemplary network environment for L5-only GNSS receiver assistance with the support of integrated L1-GNSS receiver, in accordance with an embodiment of the disclosure. With reference to FIG. 1, there is shown a network environment 100. The network environment 100 includes a system 102 that includes a modem 104, an L1-Global Navigation Satellite System (L1-GNSS) receiver 106, an L5-GNSS receiver 108, satellite constellations 110, a communication network 120, and a server 122. In accordance with an embodiment, the system 102 may communicate with the server 122, through one or more networks (such as the communication network 120). The server 122 may store a database 124, for example.

As used herein, the term “L1” refers to a specific frequency band used in Global Navigation Satellite Systems (GNSS). L1 is the primary frequency band used by GNSS signals, including GPS (Global Positioning System) and other satellite navigation systems. Similarly, the term “L5” may refer to a frequency band used in GNSS. L5 is a higher frequency band than L1 band. L5 band was initially introduced to provide additional accuracy and reliability for GNSS signals, particularly in safety-critical applications such as aviation and maritime navigation. It is important to note that specific frequencies and usage of L1 and L5 bands may vary slightly depending on the GNSS system and regional regulations.

The system 102 may be referred to as a GNSS-enabled system that may include suitable logic, circuitry, and interfaces that may be configured to receive radio frequency signals from space vehicles (such as the satellites) and track a position of the system 102. The system 102 may provide computational, storage, power, network communication, and sensor-based resources for tracking and displaying the position and other information such as a motion path. Examples of the system 102 may include a smartphone or a mobile phone, a mobile device with a modem chipset, a laptop, a smartwatch, a digital camera, a wearable glass, a wearable headband, a wearable fitness tracker, a telematics unit of a vehicle, or an augmented reality/virtual reality/mixed reality (AR/VR/MR) device. The system 102 may be used in a variety of applications, including but not limited to advanced driver assistance systems (ADAS), unmanned aerial vehicles (UAVs), and Internet of Things (IoT).

The modem 104 may be described as a hardware device or chipset that may facilitate communication between a computer or electronic device (such as the system 102) and a network (such as a telecom network). In the case of a specific implementation like a cellular modem, the modem 104 may serve a specialized chipset designed to support cellular network technology and may enable devices (such as the system 102) to connect to and communicate over 5G networks, offering significantly faster data speeds, lower latency, and increased network capacity compared to previous generations. Examples of the modem 104 may include, but are not limited to, a cellular modem, a Narrow Band-Internet of Things (NB-IOT) modem, or a Long-Term Evolution for Machines (LTE-M) modem. Other examples of the modem 104 may include Long Term Evolution Category 1 (LTE-Cat 1) modem, LTE-Cat 1 Bis modem, Reduced Capability (RedCap) modem, and eRedCap modem.

The modem 104 may include the L1-GNSS receiver 106, which may include suitable logic, circuitry, interfaces, and/or code that may be configured to acquire L1-GNSS signals. The L1-GNSS receiver 106 may communicate with satellites (that support L1 Band) of at least one constellation of the satellite constellations 110.

As shown, for example, the satellite constellations 110 may include satellite constellation 110A and satellite constellation 110B. The L1-GNSS receiver 106 may acquire the L1-GNSS signals from the satellite constellation 110A or the satellite constellation 110B. The number of satellite constellations (110A and 110B) in FIG. 1 is presented merely as an example and such an example should not be construed as limiting for the disclosure.

The satellite constellation 110A or the satellite constellation 110B may include L1-based satellite system, L2-based satellite system, L5-based satellite system, or a combination thereof. Each of the satellite constellation 110 may include a group of artificial satellites working together as a system and orbiting the earth in defined orbits and at specific altitudes. Each satellite of the satellite constellation 110A and the satellite constellation 110B may periodically broadcast information, such as satellite's ephemeris, satellite's almanac, satellite's health and clock data, and ionospheric data to earth. Such satellites may be controlled and monitored by a network of ground stations on earth. Examples of the satellite constellation 110A (or the satellite constellation 110B) may include, but are not limited to, Global Positioning System (GPS), Global Navigation Satellite System (GLONASS), Indian Regional Navigation Satellite System (IRNSS), BeiDou System, Quasi-Zenith Satellite System (QZSS), and a Galileo System.

Further, the satellite constellation 110A may include a first set of satellites, including a satellite 112A, a satellite 112B, a satellite 112C, . . . , and a satellite 112N. The satellite constellation 110B may include a second set of satellites, including a satellite 116A, a satellite 116B, a satellite 116C, . . . , and a satellite 116N. The number of satellites in the satellite constellation 110A and 110B in FIG. 1 are presented merely as an example and should not be construed as limiting for the disclosure. In an embodiment, the L1-GNSS receiver 106 may acquire the L1-GNSS signals from the satellite constellation 110A by communicating with each satellite (that supports L1 communication) of the first set of satellites 112A . . . 112N of the satellite constellation 110A. In another embodiment, the L1-GNSS receiver 106 may acquire the L1-GNSS signals from the satellite constellation 110B by communicating with each satellite (that supports L1 communication) of the second set of satellites 116A . . . 116N of the satellite constellation 110B.

The L1-GNSS receiver 106 may include suitable logic, circuitry, interfaces, and/or code that may further be configured to execute an L1-acquisition operation based on the acquired L1-GNSS signals to generate assistance information. The L1-acquisition operation may include processing of the acquired L1-GNSS signals through signal processing technique. Through the signal processing technique, necessary data may be extracted from the acquired L1-GNSS signals, and the extracted data may be converted to the assistance information. The assistance information may include, for example, time and frequency information of the acquired L1-GNSS signals, L5 acquisition information, ephemeris information, clock synchronization information, and the like.

The L5-GNSS receiver 108 may include suitable logic, circuitry, code, and/or interfaces that may be configured to support an L5 frequency band. The L5-GNSS receiver 108 may be an external chip that may be separate from the modem 104 and may be communicatively coupled to the L1-GNSS receiver 106. The L5-GNSS receiver 108 may acquire the generated assistance information from the L1-GNSS receiver 106. Further, the L5-GNSS receiver 108 may execute an L5-acquisition and tracking operation for the satellites based on the assistance information. The acquisition and tracking operation may include acquisition of L5-GNSS signals and tracking and retracking of the first or second set of satellites associated with the corresponding satellite constellation 110A or 110B.

As used herein, the GNSS receiver (e.g., L1-GNSS receiver 106 or L5-GNSS receiver 108) may be implemented through a combination of software and hardware components (e.g., on a chipset). The software may be executed to process signals and perform calculations, while the hardware may include antennas, RF modules, ADCs, and microcontrollers. This integration may enable accurate positioning and navigation based on signals received from the satellite constellations (such as the satellite constellations 110).

As used herein, the term “GNSS service provider” (e.g., GNSS service provider 114 or GNSS service provider 118) may refer to an organization or entity that operates and manages a network of satellites that make up a Global Navigation Satellite System (GNSS). These systems, such as GPS, GLONASS, Galileo, or BeiDou, provide positioning, navigation, and timing services to users worldwide. The GNSS service provider may be responsible for maintaining the satellites, monitoring performance of such satellites, and ensuring the accuracy and availability of the signals transmitted by the satellites.

The communication network 120 may include a communication medium through which the system 102 may communicate with the server 122 and other electronic devices (not described herein for the sake of brevity). The communication network 120 may be a wired or wireless communication network. Examples of the communication network 120 may include, but are not limited to, Internet, a Wireless Fidelity (Wi-Fi) network, a Personal Area Network (PAN), a Local Area Network (LAN), or a Metropolitan Area Network (MAN). The system 102 may be configured to connect to the communication network 120, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The server 122 may include suitable logic, circuitry, interfaces, and/or code that may be configured to receive data associated with the L1-GNSS signals and the L5-GNSS signals, and the assistance information. The received data may further be stored in the server 122. In an embodiment, the server 122 may generate assistance information based on the acquired L1-GNSS signals. The server 122 may be configured to transmit data such as ephemeris data to the system 102 based on requests from the system 102. The server 122 may execute operations through web applications, cloud applications, HTTP requests, repository operations, file transfer, and the like. Example implementations of the server 122 may include, but are not limited to, a database server, a file server, a web server, an application server, a mainframe server, a cloud computing server, or a combination thereof. In at least one embodiment, the server 122 may be implemented as a plurality of distributed cloud-based resources by use of several technologies that are well known to those ordinarily skilled in the art.

A person with ordinary skill in the art will understand that the scope of the disclosure may not be limited to the implementation of the server 122 and the system 102 as two separate entities. In certain embodiments, the functionalities of the server 122 may be incorporated in its entirety or at least partially in the system 102, without a departure from the scope of the disclosure.

The database 124 may include suitable logic, interfaces, and/or code that may be configured to store the L1-signals, the L5-signals, the assistance data, or other positioning data (such as ephemeris data or almanac data). The database 124 may also store signal strength of the received L1-signals and the L5-signals. The database 124 may be a relational database, a non-relational database, or a set of comma-separated values (csv) files in conventional or big-data storage. The database 124 may be stored or cached on a device, such as the server 122. The server 122 storing the database 124 and the system 102 may interact with each other. During the interaction, the system 102 may query for the assistance data or data related to the acquired L1-GNSS signals or the L5-GNSS signals. In response to the query, the server 122 may be configured to retrieve results from the database 124.

In some embodiments, the database 124 may be hosted on a plurality of servers stored at same or different locations. The operations of the database 124 may be executed using hardware including a processor, a microprocessor (e.g., to perform or control performance of one or more operations), a field-programmable gate array (FPGA), or an application-specific integrated circuit (ASIC). In some other instances, the database 124 may be implemented using software.

In operation, the L1-GNSS receiver 106 of the system 102 may be configured to acquire L1-GNSS signals from satellites of at least one satellite constellation of the satellite constellations 110 (such as the satellite constellation 110A, the satellite constellation 110B, and so on). In an embodiment, the L1-GNSS receiver 106 may receive information associated with one or more external conditions of the L1-GNSS receiver 106. The information associated with such external conditions may be received in a duration of the acquisition of the L1-GNSS signals or may be received prior to or after the acquisition of the L1-GNSS signals. The information may be received periodically or based on one or more events (e.g. user query, loss of communication with the satellite constellations 110, unusual functioning, and the like). By way of example, and not limitation, the information may include data about actual functioning of distinct components of the L1-GNSS receiver 106, a strength of the acquired signal, a motion of the L1-GNSS receiver 106 in a duration of the acquisition of the L1-GNSS signals, or a Bit Error Rate (BER) associated with a decoding operation for a previously acquired signal.

The received information may include a user input to indicate a selection of a GNSS service provider from amongst a plurality of GNSS service providers (for instance, the GNSS service provider 114 and the GNSS service provider 118). The modem 104 may determine a priority for one or more GNSS service providers of the plurality of GNSS service providers based on the user input or a preset configuration. The L1-GNSS signals may be acquired from the satellites associated with the one or more GNSS service providers based on the determined priority. For example, a priority may be given to GPS or a combination of GPS and Galileo service providers over Beidou or other GNSS service providers.

The L1-GNSS receiver 106 may be configured to execute an L1-acquisition operation based on the acquired L1-GNSS signals. For L1-acqusition, the L1-GNSS receiver 106 may detect the L1-GNSS signals from the satellites by scanning the frequency spectrum to identify the L1-GNSS signals that match the expected characteristics. The L1-GNSS receiver 106 must align a locally generated pseudorandom noise (PRN) code with the incoming L1-GNSS signals from the satellites to determine a code phase, which may be achieved by correlating the acquired L1-GNSS signals with the locally generated PRN code at various time shifts. Additionally, due to the relative motion between the satellites and the L1-GNSS receiver 106, the frequency of the acquired L1-GNSS signals may be shifted (Doppler effect), and the L1-acquisition may include estimation of this Doppler shift to correctly tune a local oscillator included in the L1-GNSS receiver 106. The L1-acquisition may provide a coarse estimate of the satellite's signal parameters, including the code phase and Doppler frequency, which may be used to initialize tracking loops that may further refine these estimates of the satellite's signal parameters.

Once a signal is detected and associated parameters are estimated, the L1-GNSS receiver 106 may identify the satellite(s) from which the L1-GNSS signals may be coming from by matching the PRN code to known satellite(s) in the satellite constellations. The match may enable the L1-GNSS receiver 106 to lock onto the L1-GNSS signals of such satellites, which may be necessary for subsequent steps like signal tracking and navigation data decoding.

After the acquisition, the L1-GNSS receiver 106 may generate assistance information for other onboard receivers such as the L5-GNSS receiver 108. The assistance information may be transmitted to the L5-GNSS receiver 108 through a suitable interface between the modem 104 and the L5-GNSS receiver 108. The assistance information may aid the L5-GNSS receiver 108 in faster acquisition and reacquisition of L5-GNSS signals.

In an exemplary embodiment, the assistance information may include at least one of time and frequency information of the acquired L1-GNSS signals, L5 acquisition information, ephemeris information, and clock synchronization information. The time and frequency information related to the acquired L1-GNSS signals may be crucial for understanding and analyzing the performance of corresponding satellite constellations 110. The L5 acquisition information may refer to the details and processes involved in acquiring and tracking the L5 frequency signal of any satellites of the first set of satellites 112A . . . 112N of the satellite constellation 110A or the second set of satellites 116A . . . 116N of the satellite constellation 110B. The L5 frequency band may be used in modernized GNSS systems, such as GPS and Galileo, to provide enhanced accuracy, integrity, and availability of positioning information.

The ephemeris information may be vital for accurate positioning and navigation in the GNSS systems. The ephemeris information may refer to the data that describes the precise orbital parameters and positions of the satellites in the respective satellite constellations 110 at a given time. Further, the ephemeris data may include information such as the satellite's position, velocity, and clock offset. This data may be essential to calculate the satellite's position relative to the L1-GNSS receiver's location accurately. The ephemeris information is typically transmitted by the satellites as part of the navigation message. The L1-GNSS receiver 106 may receive and decode the ephemeris information to determine the satellite's position and other relevant parameters. The ephemeris information is time-sensitive and continuously updated as the satellites move in respective orbits. The L1-GNSS receiver 106 may need to regularly acquire and update the ephemeris information to maintain accurate positioning of the satellites of a specific satellite constellation of the satellite constellations 110. The ephemeris information may be typically provided by the GNSS service providers (e.g. GNSS service providers 114 or 118 of FIG. 1) or through augmentation services. These services ensure that the L1-GNSS receiver 106 has access to the up-to-date and accurate ephemeris information.

The clock synchronization information in the GNSS systems is essential for accurate positioning and timing measurements. The clock synchronization information may refer to data that may enables the L1-GNSS receiver 106 to synchronize clocks on the L1-GNSS receiver 106 with the highly accurate atomic clocks on board the GNSS satellites. The clocks on GNSS satellites are extremely precise and are used to generate the timing signals that may be transmitted to various receivers. However, due to various factors such as signal propagation delays and receiver clock inaccuracies, there may be discrepancies between the satellite clock and the clocks of the L1-GNSS receiver 106. To achieve accurate positioning and timing, the L1-GNSS receiver 106 may need to synchronize the clocks with the satellite clocks. This may be done by extracting clock synchronization information from the L1-GNSS signals received by the L1-GNSS receiver 106. The clock synchronization information is typically included in the navigation message transmitted by the satellites and contains parameters such as the satellite clock offset and drift, which may be used by the L1-GNSS receiver 106 to adjust clocks associated with the L1-GNSS receiver 106 to match the satellite clocks. By continuously monitoring the acquired L1-GNSS signals and comparing them to the known satellite clock information, the L1-GNSS receiver 106 may adjust the clocks to maintain synchronization.

The L1-GNSS receiver 106 may significantly enhance the acquisition and tracking processes of other onboard GNSS receivers such as the L5-GNSS receiver 108 by generating the assistance information for such receivers. For instance, the assistance information may include coarse estimates of the satellite's signal parameters, such as code phase and Doppler frequency, which may help to narrow down the search space for the L5-GNSS receiver 108. Additionally, the L1-GNSS receiver 106 may decode satellite ephemeris data, offering the L5-GNSS receiver 108 precise satellite position and velocity information. By identifying visible satellites and corresponding PRN codes, the L1-GNSS receiver 106 may allow the L5-GNSS receiver 108 to focus on specific signals, expediting acquisition. Ionospheric delay corrections from the L1-GNSS receiver 106 may improve the accuracy of L5 signal processing, while initial position and velocity estimates may help the L5-GNSS receiver 108 to refine calculations performed on the L5-GNSS receiver 108. Furthermore, time synchronization provided by the L1-GNSS receiver 106 may ensure that the clock on the L5-GNSS receiver 108 is accurately aligned with GNSS system time. Overall, leveraging the assistance information from the L1-GNSS receiver 106 may enable the L5-GNSS receiver 108 to achieve faster and more reliable GNSS performance, and a faster time-to-first fix (TTFF) especially in environments where satellite signals are weak or obstructed.

After the L1-acquisition operation, the L5-GNSS receiver 108 may acquire the generated assistance information from the L1-GNSS receiver 106. The L5-GNSS receiver 108 may be an external chip that may be separate from the modem 104 and communicatively coupled to the L1-GNSS receiver 106.

The L5-GNSS receiver 108 may execute an L5-acquisition and tracking operation for the satellites based on the assistance information. The acquisition and tracking operation may include acquisition of L5-GNSS signals, tracking and retracking of the first or second set of satellites associated with the corresponding satellite constellation 110A or 110B, which may be in communication with the system 102. Once the L5-GNSS signals are acquired, the L5-GNSS receiver 108 may then track and decode navigation data in the L5-GNSS signals to determine accurate positioning, velocity, and timing information. As an example, the L5-GNSS receiver 108 may determine the time and frequency information and a code delay for the L5-GNSS signals based on the execution of the L5-acquisition and tracking operation. Further, the L5-GNSS receiver 108 may acquire the L5-GNSS signals from the set of satellites of the selected satellite constellation 110A or 110B. Thereafter, the L5-GNSS receiver 108 may decode the acquired L5-GNSS signals based on the time and frequency information and the code delay to extract the navigation data from the L5-GNSS signals.

In an embodiment, acquisition of the L5 GNSS signals may be based on the ability of the L5-GNSS receiver 108 to detect and lock onto the L5 frequency transmitted by the first or second set of satellites associated with the corresponding satellite constellation 110A or 110B. The acquisition process may typically include searching for the L5 GNSS signals, synchronizing with the satellite's timing, and establishing a stable connection. During the acquisition and tracking operation, the L5-GNSS receiver 108 may utilize the assistance information to perform various operations, such as to correlate the acquired assistance information with a locally generated replica, to adjust frequency and timing to match the L5-GNSS signals for a satellite constellation (of the satellite constellations 110), and to evaluate signal quality.

In an embodiment, the modem 104 may be configured to deactivate or power off the L1-GNSS receiver 106 along with a Radio Frequency (RF) component for the L1-GNSS receiver 106 based on the acquisition of the generated assistance information. Specifically, after a specific time-duration of synchronization of the communication between the L5-GNSS receiver 108 and the satellites of the selected satellite constellation 110A or 110B, the modem 104 may deactivate or power off the L1-GNSS receiver 106.

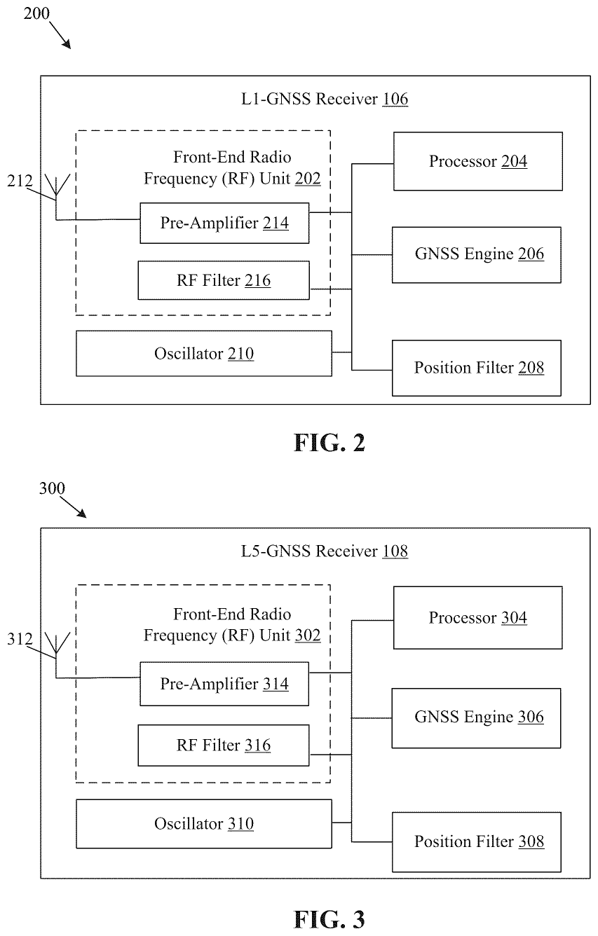

FIG. 2 is a block diagram of L1-GNSS receiver of FIG. 1, in accordance with an embodiment of the disclosure. FIG. 2 is explained in conjunction with elements from FIG. 1. With reference to FIG. 2, there is shown a block diagram 200 of the L1-GNSS receiver 106. The L1-GNSS receiver 106 may include a front-end Radio Frequency (RF) unit 202, a processor 204, a GNSS engine 206, a position filter 208, and an oscillator 210.

In at least one embodiment, the front-end RF unit 202 may include an antenna 212, a pre-amplifier 214, and a RF filter 216. The antenna 212 may be configured to receive RF signals (for example, L1-GNSS signals) from one or more satellites, such as the first set of satellites 112A . . . 112N of the satellite constellation 110A or the second set of satellites 116A . . . 116N of the satellite constellation 110B. The RF signals may include ephemerides or ephemeris data of such satellites. Examples of the antenna 212 may include, but are not limited to, a quadrifilar antenna, a patch or microstrip antenna, a dipole antenna, a choke ring antenna, a helix antenna, or a planar ring antenna.

The pre-amplifier 214 may be configured to amplify the RF signals received by the antenna 212. As the received RF signals may be weak, the pre-amplifier 214 may be required to increase the power of the received RF signals while ensuring that the gain in power is higher than the noise included in the received RF signals.

The RF filter 216 may be configured to improve a selectivity of the front-end RF unit 202 of the L1-GNSS receiver 106. Specifically, the RF filter 216 may reject unwanted frequencies and may block out-of-band interfering signals from the amplified RF signals. Examples of the RF filter 216 may include, but not limited to, Bulk Acoustic Wave (BAW) filter, Surface Acoustic Wave (SAW) filter, or any other RF filter. In case the RF filter 216 is implemented as a SAW filter or a BAW filter, the RF filter 216 may operate based on conversion of electrical energy into acoustic or mechanical energy on a piezoelectric material.

The processor 204 may include suitable logic, circuitry, interfaces, and/or code that may be configured to execute program instructions associated with different operations to be executed by the L1-GNSS receiver 106. The processor 204 may control operations of all components of the L1-GNSS receiver 106. The operations to be executed by the L1-GNSS receiver 106 may include acquisition of L1-GNSS signals from one or more satellites of the satellite constellation 110A or the satellite constellation 110B and an L1-acquisition operation. The operations to be executed by the processor 204 may also include reception of information associated with one or more external conditions that impact one or more of a decoding performance of the L1-GNSS receiver 106, computation of a strength of the acquired L1-GNSS signals, performance of measurements associated with one or more parameters of a carrier component of the L1-GNSS signals and decoding of satellite data from the acquired L1-GNSS signals.

In some embodiments, the processor 204 may be configured to estimate positions of one or more satellites of the first set of satellites 112A . . . 112N of the satellite constellation 110A or one or more satellites of the second set of satellites 116A . . . 116N of the satellite constellation 110B. In an embodiment, the processor 204 may be configured to execute position fixing operation of the L1-GNSS receiver 106. Examples of the processor 204 may be an x86-based processor, an x64-based processor, a Reduced Instruction Set Computing (RISC) processor, an Application-Specific Integrated Circuit (ASIC), a Complex Instruction Set Computing (CISC) processor, a field-programmable gate array-based processor, a specialized digital signal processor (DSP), or other processors, and the like.

The GNSS engine 206 of the L1-GNSS receiver 106 may be configured to execute operations of the L1-GNSS receiver 106 on the processor 204. The GNSS engine 206 may include several modules, such as acquisition unit, tracking unit, or navigation unit. Each of such modules may be implemented as program instructions, specialized circuitry, or a combination thereof. The GNSS engine 206 may be configured to process the acquired L1-GNSS signals and generate the assistance information.

The position filter 208 may include suitable logic, circuitry, interfaces, and/or code that may be configured to determine a position fix for the L1-GNSS receiver 106 (i.e., the system 102) based on estimated positions of one or more satellites of the selected satellite constellation of the satellite constellations 110. In some instances, the position filter 208 may be implemented as a software component, as something running on the L1-GNSS receiver 106 and may implement Kalman filtering or least-square estimators to determine the position fix. In some embodiments, the position filter 208 may be controlled or reset to utilize correctly decoded ephemeris. Typically, the position filter 208 may be affected by previous state stored. If mis-decoded ephemeris is used in previous measurement, then the position of the L1-GNSS receiver 106 may need to be recovered immediately without dragging wrong information, as soon as correct ephemeris is decoded.

The oscillator 210 may be configured to provide mechanical resonance of a vibrating crystal, thereby creating an electrical signal of a particular frequency. In an embodiment, the oscillator 210 may be a crystal oscillator with a temperature sensitive reactance circuit to compensate frequency-temperature characteristics of the crystal. Examples of the oscillator 210 may include, but are not limited to, a temperature compensated crystal oscillator (TCXO), Oven controlled crystal oscillator (OCXO), or any other crystal oscillator.

A person of ordinary skill in the art will understand that the L1-GNSS receiver 106 in FIG. 2 may include other suitable components or systems (for example, analog filters, intermediate frequency (IF) mixers or amplifiers, down-converters, A/D converters, and the like), in addition to the components or systems which are illustrated herein to describe and explain the function and operation of the present disclosure. The functions or operations executed by the L1-GNSS receiver 106, as described in FIG. 1, may be performed by the processor 204.

FIG. 3 is a block diagram L5-GNSS receiver of FIG. 1, in accordance with an embodiment of the disclosure, in accordance with an embodiment of the disclosure. FIG. 3 is explained in conjunction with elements from FIG. 1 and FIG. 2. With reference to FIG. 3, there is shown a block diagram 300 of the L5-GNSS receiver 108. The L5-GNSS receiver 108 may include a front-end Radio Frequency (RF) unit 302, a processor 304, a GNSS engine 306, a position filter 308, and an oscillator 310.

In at least one embodiment, the front-end RF unit 302 may include an antenna 312, a pre-amplifier 314, and a RF filter 316. The antenna 312 may be configured to receive RF signals (for example, L1-GNSS signals) from one or more satellites, such as the first set of satellites 112A . . . 112N of the satellite constellation 110A or the second set of satellites 116A . . . 116N of the satellite constellation 110B. The RF signals may include ephemerides or ephemeris data of such satellites. Examples of the antenna 312 may include, but are not limited to, a quadrifilar antenna, a patch or microstrip antenna, a dipole antenna, a choke ring antenna, a helix antenna, or a planar ring antenna.

The pre-amplifier 314 may be configured to amplify the RF signals received by the antenna 312. As the received RF signals may be weak, the pre-amplifier 314 may be required to increase the power of the received RF signals while ensuring that the gain in power is higher than the noise included in the received RF signals.

The RF filter 316 may be configured to improve a selectivity of the front-end RF unit 302 of the L5-GNSS receiver 108. Specifically, the RF filter 316 may reject image frequencies and may block out-of-band interfering signals from the amplified RF signals. Examples of the RF filter 316 may include, but not limited to, Bulk Acoustic Wave (BAW) filter, Surface Acoustic Wave (SAW) filter, or any other RF filter. In case the RF filter 316 is implemented as a SAW filter or a BAW filter, the RF filter 316 may operate based on conversion of electrical energy into acoustic or mechanical energy on a piezoelectric material.

The processor 304 may include suitable logic, circuitry, interfaces, and/or code that may be configured to execute program instructions associated with different operations to be executed by the L5-GNSS receiver 108. The processor 304 may control operations of all components of the L5-GNSS receiver 108. The operations to be executed by the L5-GNSS receiver 108 may include receipt of the assistance information from the L1-GNSS receiver 106 and an L5-acquisition and tracking operation. The operations to be executed by the processor 304 may also include decoding of the acquired L5-GNSS signals based on the time and frequency information and the code delay to extract the navigation data from the L5-GNSS signals. The reception of information associated with one or more external conditions that impact one or more of a decoding performance of the L5-GNSS receiver 108, computation of a strength of the acquired L1-GNSS signals/L5-GNSS signals. The operations to be executed by the processor 304 may also include establishing direct communication between the L5-GNSS receiver 108 and the selected satellite constellation of the satellite constellations 110, i.e. synchronization of the communication between the L5-GNSS receiver 108 and the selected satellite constellation of the satellite constellations 110.

In some embodiments, the processor 304 may be configured to estimate positions of one or more satellites of the first set of satellites 112A . . . 112N of the satellite constellation 110A or one or more satellites of the second set of satellites 116A . . . 116N of the satellite constellation 110B. In an embodiment, the processor 304 may be configured to execute position fixing operation of the L5-GNSS receiver 108. Examples of the processor 304 may be an x86-based processor, an x64-based processor, a Reduced Instruction Set Computing (RISC) processor, an Application-Specific Integrated Circuit (ASIC), a Complex Instruction Set Computing (CISC) processor, a field-programmable gate array-based processor, a specialized digital signal processor (DSP), or other processors, and the like.

The GNSS engine 306 of the L5-GNSS receiver 108 may be configured to execute operations of the L5-GNSS receiver 108 on the processor 304. The GNSS engine 306 may include several modules, such as an acquisition unit, a tracking unit, or a navigation unit. Each of such modules may be implemented as program instructions, specialized circuitry, or a combination thereof. The GNSS engine 306 may be configured to process the assistance information, and track and retrack associated satellite constellations 110.

The position filter 308 may include suitable logic, circuitry, interfaces, and/or code that may be configured to determine a position fix for the L5-GNSS receiver 108 (i.e., the system 102) based on estimated positions of one or more satellites of the selected satellite constellation of the satellite constellations 110. In some instances, the position filter 308 may be implemented as a software component, as something running on the L5-GNSS receiver 108 and may implement Kalman filtering or least-square estimators to determine the position fix. In some embodiments, the position filter 308 may be controlled or reset to utilize correctly decoded ephemeris. Typically, a position filter is affected by the previous state. If mis-decoded ephemeris is used in previous measurement, then the position of the L5-GNSS receiver 108 may need to be recovered immediately without dragging wrong information, as soon as correct ephemeris is decoded.

The oscillator 310 may be configured to provide mechanical resonance of a vibrating crystal, thereby creating an electrical signal of a particular frequency. In an embodiment, the oscillator 310 may be a crystal oscillator with a temperature sensitive reactance circuit to compensate frequency-temperature characteristics of the crystal. Examples of the oscillator 310 may include, but are not limited to, a temperature compensated crystal oscillator (TCXO), Oven controlled crystal oscillator (OCXO), or any other crystal oscillator.

A person of ordinary skill in the art will understand that the L5-GNSS receiver 108 in FIG. 3 may include other suitable components or systems (for example, analog filters, intermediate frequency (IF) mixers or amplifiers, down-converters, A/D converters, and the like), in addition to the components or systems which are illustrated herein to describe and explain the function and operation of the present disclosure. The functions or operations executed by the L5-GNSS receiver 108, as described in FIG. 1, may be performed by the processor 304.

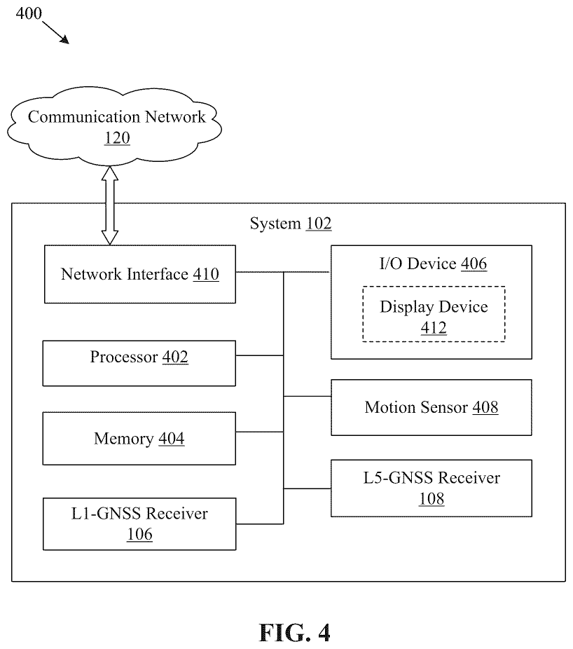

FIG. 4 is an exemplary block diagram that illustrates the system that includes the L1-GNSS receiver of FIG. 2 and the L5-GNSS receiver of FIG. 3, in accordance with an embodiment of the disclosure. FIG. 4 is explained in conjunction with elements from FIG. 1, FIG. 2, and FIG. 3. With reference to FIG. 4, there is shown an exemplary block diagram 400 of the system 102. The system 102 may include the L1-GNSS receiver 106, the L5-GNSS receiver 108, a processor 402, a memory 404, an input/output (I/O) device 406, a motion sensor 408, and a network interface 410. In at least one embodiment, the I/O device 406 may also include a display device 412. The processor 402 may be communicatively coupled to the L1-GNSS receiver 106, the L5-GNSS receiver 108 (interchangeably, also referred to as L5-GNSS receiver 108, herein), the memory 404, the I/O device 406, and the network interface 410, through wired or wireless communication of the system 102.

The processor 402 may include suitable logic, circuitry, and interfaces, and/or code that may be configured to execute program instructions associated with different operations to be executed by the system 102. In accordance with an embodiment, the operations may be associated with the L1-GNSS receiver 106 and the L5-GNSS receiver 108. The operations include acquisition of L1-GNSS signals from one or more satellites of the satellite constellation 110A or the satellite constellation 110B, an L1-acquisition operation execution, receipt of the assistance information from the L1-GNSS receiver 106 and an L5-acquisition and tracking operation execution. The operations to be executed by the processor 402 may also include reception of information associated with one or more external conditions that impact one or more of a decoding performance of the L1-GNSS receiver 106, computation of a strength of the acquired L1-GNSS signals, performance of measurements associated with one or more parameters of a carrier component of the L1-GNSS signals and decoding of satellite data from the acquired L1-GNSS signals. Further, the operations to be executed by the processor 402 may also include decoding of the acquired L5-GNSS signals based on the time and frequency information, the code delay to extract the navigation data from the L5-GNSS signals.

The processor 402 may include one or more specialized processing units, which may be implemented as an integrated processor or a cluster of processors that perform the functions of the one or more specialized processing units, collectively. The processor 402 may be implemented based on a number of processor technologies known in the art. Examples of implementations of the processor 402 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The memory 404 may include suitable logic, circuitry, interfaces, and/or code that may be configured to store the program instructions to be executed by the processor 402. The program instructions stored on the memory 404 may enable the processor 402 to execute the operations associated with the L1-GNSS receiver 106 or the L5-GNSS receiver 108. In at least one embodiment, the memory 404 may store the received information associated with external conditions that impact decoding performance of the L1-GNSS receiver 106 or the L5-GNSS receiver 108. The memory 404 may further store assistance information, strength of the acquired L1-GNSS signals/L5-GNSS signals, obtained from the database 124. Examples of implementation of the memory 404 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 406 may include suitable logic, circuitry, interfaces, and/or code that may be configured to receive an input and provide an output based on the received input. In accordance with an embodiment, the input may be associated with the assistance information, an external condition that impacts a decoding performance of the L1-GNSS receiver 106 or the L5-GNSS receiver 108. For example, the I/O device 406 may receive a user input from a user associated with the system 102. The user input may be indicative of a selection of a GNSS service provider from amongst the plurality of GNSS service providers, for instance the GNSS service provider 114 and the GNSS service provider 118. The I/O device 406 may render, as output, the assistance information.

In an example, the selected GNSS provider may be associated with a GNSS satellite constellation (for example, the satellite constellation 110A or 110B). The I/O device 406 may render an output that indicates the selected satellite constellation 110A or 110B and the one or more satellites (for example, the satellite 112A) from where the L1-GNSS signals or the L5-GNSS signals are acquired. The I/O device 406 may render one or more parameters of the acquired signal such as received signal power, signal strength, frequency, or the like. Examples of the I/O device 406 may include, but are not limited to, a touch screen, a keyboard, a mouse, a joystick, a microphone, the display device 412, and a speaker.

The I/O device 406 may include the display device 412. The display device 412 may include suitable logic, circuitry, and interfaces that may be configured to receive inputs from the processor 402 to render, on a display screen, an interface that allows the user to provide the user inputs. In at least one embodiment, the display screen may be at least one of a resistive touch screen, a capacitive touch screen, or a thermal touch screen. The display device 412 or the display screen may be realized through several known technologies such as, but not limited to, at least one of a Liquid Crystal Display (LCD) display, a Light Emitting Diode (LED) display, a plasma display, or an Organic LED (OLED) display technology, or other display devices.

The motion sensor 408 may include suitable logic, circuitry, interfaces, and/or code that may estimate motion or movement of the L1-GNSS receiver 106 or the L5-GNSS receiver 108. The movement or motion may be estimated based on a linear or an angular displacement of the L1-GNSS receiver 106 or the L5-GNSS receiver 108. Example of the motion sensor 408 may include, but are not limited to, Hall effect sensors, variable reluctance speed sensors, RF speed sensors, accelerometer-based speed sensors, optical speed sensors, or the like.

The network interface 410 may include suitable logic, circuitry, and interfaces that may be configured to facilitate a communication between the processor 402 of the system 102 and the server 122, via the communication network 120. The network interface 410 may be implemented by use of various known technologies to support wired or wireless communication of the system 102 with the communication network 120. The network interface 410 may include, but is not limited to, an antenna, a RF transceiver, one or more amplifiers, a tuner, one or more oscillators, a digital signal processor, a coder-decoder (CODEC) chipset, a subscriber identity module (SIM) card, or a local buffer circuitry.

The network interface 410 may be configured to communicate via wireless communication with networks, such as the Internet, an Intranet, or a wireless network, such as a cellular telephone network, a wireless local area network (LAN), a short-range communication network, and a metropolitan area network (MAN). The wireless communication may use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a near field communication protocol, and a wireless pear-to-pear protocol.

The functions or operations associated with the L1-GNSS receiver 106 or the L5-GNSS receiver 108, executed by the system 102, as described in FIG. 1, may be performed by the processor 402.

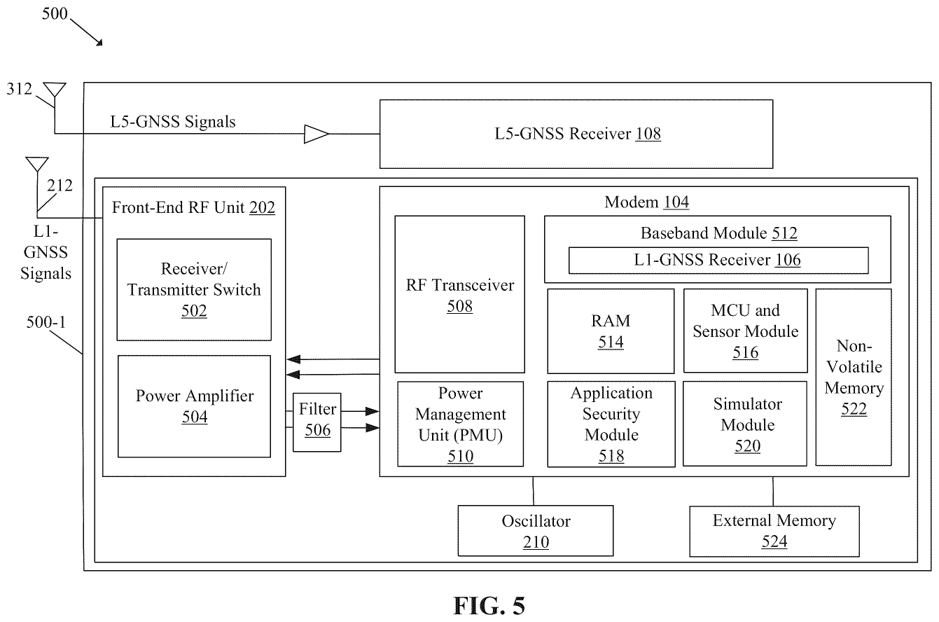

FIG. 5 is an exemplary block diagram that illustrates a chipset for L5-GNSS receiver assistance with the support of integrated L1-GNSS receiver. FIG. 5 is explained in conjunction with elements from FIG. 1, FIG. 2, FIG. 3, and FIG. 4. With reference to FIG. 5, there is shown an exemplary block diagram of a device 500 that includes a chipset 500-1. The chipset 500-1 includes the L5-GNSS receiver 108 that supports an L5 frequency band. The L5-GNSS receiver 108 may be communicatively coupled to the L1-GNSS receiver 106 embedded in the modem 104. The details related to functioning of the L5-GNSS receiver 108, are described, for example, in FIG. 1 and FIG. 3.

The front-end RF unit 202 associated with the L1-GNSS receiver 106 may include the antenna 212, which may be configured to receive the L1-GNSS signals from one or more satellites associated with the satellite constellation 110A or the satellite constellation 110B.

The front-end RF unit 202 may further include a receiver/transmitter switch 502 and a power amplifier 504. The receiver/transmitter switch 502 (interchangeably, referred to as switch 502, herein) may facilitate switching between transmitting (TX) and receiving (RX) modes. This switch 502 may ensure that the modem 104 may alternate between sending data to a network and receiving data from the network without interference.

In the receiving mode, the switch 502 may connect the antenna 212 to input of the front-end RF unit 202, allowing the front-end RF unit 202 to receive signals from the satellites. The received signals may be then transmitted to the L1-GNSS receiver 106, which may process the received signals to determine corresponding position, velocity, and timing information. In the transmitting mode, the switch 502 may disconnect the antenna 212 from the input of the front-end RF unit 202and may connect the antenna 212 to a transmitter. This may allow the front-end RF unit 202to transmit signals, such as correction data or positioning information, to other devices or systems. The switch 502 may be typically controlled by the front-end RF unit's firmware or software, which may determine when to switch between the receiving and transmitting modes based on the user's requirements and the specific operation of the front-end RF unit 202. It is important to note that the specific functionality and operation of the switch 502 may vary depending on the model of the front-end RF unit 202, the L1-GNSS receiver 106 and its intended application.

The power amplifier 504 plays a crucial role in enhancing strength and quality of the L1-GNSS signals received from the satellites. The primary function of the power amplifier 504 is to amplify the weak signals received by the antenna 212 before these signals are processed by the L1-GNSS receiver 106. The signals transmitted by the satellites become relatively weak by the time they reach the Earth's surface. This is due to the long distance traveled and the attenuation caused by various factors such as atmospheric conditions and physical obstructions. The power amplifier 504 may help to overcome these challenges by boosting the power level of the received L1-GNSS signals. By amplifying the received L1-GNSS signals, the power amplifier 504 increases strength of the signals, hence making it easier to detect and process the L1-GNSS signals at the L1-GNSS receiver 106. This improves ability of the L1-GNSS receiver 106 to accurately measure the time of arrival and the phase of the received signals, which are essential for precise positioning and navigation. Additionally, the power amplifier 504 may help to compensate for signal losses that may occur due to cable or connector losses between the front-end RF unit 202 and the L1-GNSS receiver 106. Hence, the power amplifier 504 ensures that the amplified signals reach the L1-GNSS receiver 106 with minimal loss, maximizing the overall system performance.

Further, a filter 506 may be connected in between the power amplifier 504 and the modem 104. The filter 506 may be an RF filter, which may reject unwanted frequencies and may block out-of-band interfering signals from the amplified L1-GNSS signals. Examples of the filter 506 may include, but not limited to, Bulk Acoustic Wave (BAW) filter, Surface Acoustic Wave (SAW) filter, or any RF filter. In case the filter 506 is implemented as a SAW filter or a BAW filter, the filter 506 may operate based on conversion of electrical energy into acoustic or mechanical energy on a piezoelectric material.

The modem 104 may include an RF transceiver 508. The functioning of the RF transceiver 508 may involve bidirectional communication by transmitting and receiving RF signals. The RF transceiver 508 may seamlessly switch between the transmitter and receiver functions, allowing for two-way communication.

The modem 104 may further include a power management unit (PMU) 510. The PMU 510 may be responsible for managing and regulating the power supply within the modem 104. The primary function of the PMU 510 is to ensure efficient power distribution and control, maximizing the performance and lifespan of components of the modem 104, such as, baseband module 512, RF transceiver 508, and the L1-GNSS receiver 106. The PMU 510 may work by monitoring the power input and output, as well as the power requirements of different components. The PMU 510 may also regulate voltage levels, current flow, and power consumption of the components to ensure optimal operation. This includes tasks such as voltage conversion, power sequencing, and power gating. One of the key features of the PMU 510 is its ability to handle power transitions, such as power-on and power-off sequences. The PMU 510 ensures that the system 102 may power up and may shut down in a controlled manner, preventing any damage or data loss. Additionally, the PMU 510 may incorporate various power-saving techniques, such as power scaling and dynamic voltage and frequency scaling (DVFS). These techniques adjust the power supply based on the workload and performance requirements, allowing for energy efficiency and extended battery life in mobile devices.

The modem 104 may further include a baseband module 512, which may include the L1-GNSS receiver 106 and other modules such as Wi-Fi® or LTE. The baseband module 512 may act as a critical component that performs several key functions in the system 102. The primary role of the baseband module 512 is to process the L1-GNSS signals acquired from the satellites and extract the necessary information for accurate positioning and navigation. The baseband module 512 may communicate navigation solutions to a user or a host system through various output interfaces, such as UART, USB, or SPI. This allows the user to utilize the information for navigation, mapping, or other applications. Overall, the baseband module 512 may execute signal processing, data extraction, and navigation computation. Further, accurate functioning of the baseband module 512 is essential for providing reliable and precise positioning and navigation capabilities.

The modem 104 may further include a Random Access Memory (RAM) 514, which may be used for temporary storage of data that is actively being used by the L1-GNSS receiver 106. RAM 514 is a volatile memory, meaning that contents stored in the RAM 514 are lost when the system 102 or the modem 104 is powered off or restarted.

The modem 104 may further include a Microcontroller unit (MCU) and sensor module 516. The MCU and sensor module 516 may vary depending on the specific application and the type of sensors involved. The MCU is a small computer on a single integrated circuit that contains a processor core, memory, and input/output peripherals. The MCU and sensor module 516 act as the brain of the system, executing program instructions and controlling the overall operation. The MCU and sensor module 516 may receive inputs from various sources, such as sensors, and processes the received inputs to perform specific tasks. The MCU and sensor module 516 may execute program code stored in a memory of the MCU and sensor module 516, making decisions and controlling the behavior of the system based on the input data. The MCU and sensor module 516 may consist of one or more sensors that detect and measure physical quantities or environmental conditions. The one or more sensors can include temperature sensors, pressure sensors, motion sensors, light sensors, etc., depending on the application. The MCU and sensor module 516 may also include additional components like amplifiers, filters, and analog-to-digital converters (ADCs) to condition and convert the sensor signals into a suitable format for the MCU. In some instances, the MCU may execute an L1-acquisition operation based on the acquired L1-GNSS signals to generate the assistance information. The details of the execution of the L1-acquisition operation, are described, for example, in FIG. 1.

The modem 104 may further include an application security module 518, which may involve the implementation of various security measures to protect an application associated with the modem 104, including the L1-GNSS receiver 106, from potential threats and vulnerabilities. The application security module 518 may execute functions like threat detection and prevention, authentication and access control, data encryption and secure communication, input validation and sanitization, security logging and auditing, security updates and patch management. The application security module 518 may work to safeguard the application and associated data by implementing a combination of preventive, detective, and corrective security measures.

The modem 104 may further include an integrated SIM (iSIM) module 520. The iSIM module 520 may involve integration of SIM functionality directly into a processor of the modem 104, which eliminates the need for a separate physical SIM card. The iSIM module 520 may support remote provisioning, enabling network operators to update or change SIM profiles over the air, which facilitates easier carrier switching and service plan updates without physical SIM replacement. Security is a key feature of the iSIM module 520, with a secure element within the processor ensuring robust protection of user credentials and data. Additionally, iSIM contributes to reduced power consumption, hence enhancing the battery life of the modem 104.

The modem 104 may further include a non-volatile memory 522. The non-volatile memory 522 retains information even in the absence of power. There are several types of non-volatile memory technologies, including Flash Memory, Read-Only Memory (ROM), Electrically Erasable Programmable Read-Only Memory (EEPROM), Ferroelectric RAM (FeRAM), Phase-Change Memory (PCM), and the like. Ability of the non-volatile memory 522 to retain data without the need for continuous power makes the non-volatile memory 522 suitable for a wide range of applications, including storage devices, embedded systems, mobile devices, and more.

The modem 104 may further include the oscillator 210. The details of functioning of the oscillator 210, are described, for example, in FIG. 2.

The modem 104 may further include an external memory 524. The external memory 524 may refer to additional storage devices that are connected to the modem 104 externally, typically through interfaces such as USB, Thunderbolt, or Ethernet. The external memory 524 may provide extra storage capacity beyond the internal storage (such as the computer's hard drive or solid-state drive) and may allow users to store and access data externally. The external memory 524 may be of various forms, including External Hard Drives, USB Flash Drives, Network Attached Storage (NAS), External Solid-State Drives (SSDs), Optical Discs, and the like.

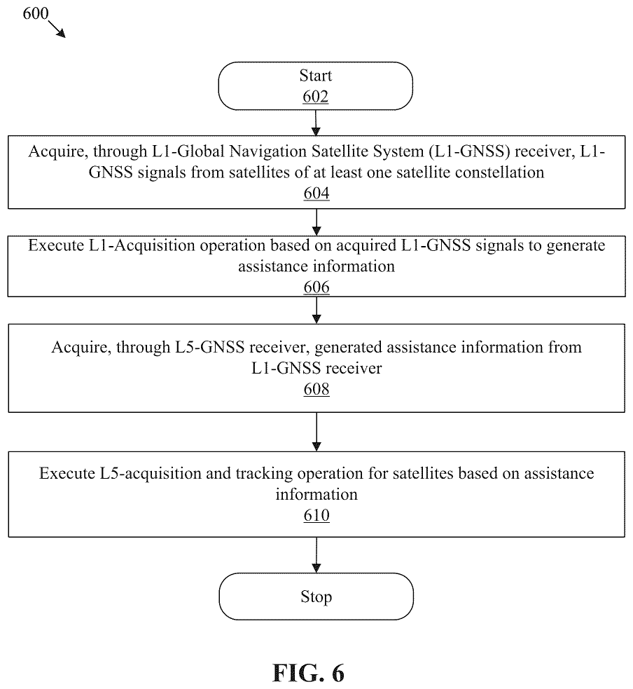

FIG. 6 is a flowchart that illustrates an exemplary method for L5-GNSS receiver assistance with the support of integrated L1-GNSS receiver, in accordance with an embodiment of the disclosure. FIG. 6 is explained in conjunction with elements from FIGS. 1, 2, 3, 4, and 5. With reference to FIG. 6, there is shown a flowchart 600. The operations from 602 to 610 may be implemented by any computing system, such as, by the system 102 of FIG.1. The operations may start at 602 and may proceed to 604.

At 604, L1-GNSS signals may be acquired. In at least one embodiment, the front-end RF unit 202 associated with the L1-GNSS receiver 106 may be configured to acquire the L1-GNSS signals from satellites of at least one satellite constellation of the satellite constellations 110. The details of acquisition of the L1-GNSS signals, are described, for example, in FIG. 1 and FIG. 2.

At 606, an L1-acquisition operation may be executed. In at least one embodiment, the processor 204 of the L1-GNSS receiver 106 may be configured to execute an L1-acquisition operation based on the acquired L1-GNSS signals to generate assistance information. The details of execution of the L1-acquisition operation are described, for example, in FIG. 1 and FIG. 2.

At 608, assistance information may be acquired. In at least one embodiment, the processor 304 of the L5-GNSS receiver 108 may be configured to acquire the generated assistance information from the L1-GNSS receiver 106. The details of acquisition of the generated assistance information, are described, for example, in FIG. 1 and FIG. 3.

At 610, an L5-acquisition and tracking operation may be executed. In at least one embodiment, the processor 304 of the L5-GNSS receiver 108 may be configured to execute an L5-acquisition and tracking operation for the satellites based on the assistance information. The details of execution of the L5-acquisition and tracking operation, are described, for example, in FIG. 1 and FIG. 3. Control may pass to end.

Although the flowchart 600 is illustrated as discrete operations, such as 604, 606, 608, and 610, the disclosure is not so limited. Accordingly, in certain embodiments, such discrete operations may be further divided into additional operations, combined into fewer operations, or eliminated, depending on the implementation without detracting from the essence of the disclosed embodiments.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. A system, comprising:
a modem comprising an L1-Global Navigation Satellite System (L1-GNSS) receiver that supports an L1 frequency band, wherein the L1-GNSS receiver is configured to:
acquire L1-GNSS signals from satellites of at least one satellite constellation; and
execute an L1-acquisition operation based on the acquired L1-GNSS signals to generate assistance information; and
an L5-GNSS receiver that supports an L5 frequency band, wherein the L5-GNSS receiver is configured to:
acquire the generated assistance information from the L1-GNSS receiver; and
execute an L5-acquisition and tracking operation for the satellites based on the assistance information.

2. The system according to claim 1, wherein the L5-GNSS receiver is an external chip that is separate from the modem and is communicatively coupled to the L1-GNSS receiver.

3. The system according to claim 1, wherein the L5-GNSS receiver is further configured to:
determine time and frequency information and a code delay for L5-GNSS signals based on the execution of the L5-acquisition and tracking operation;
acquire the L5-GNSS signals from the satellites; and
decode the acquired L5-GNSS signals based on the time and frequency information and the code delay to extract navigation data from the L5-GNSS signals.

4. The system according to claim 1, wherein the modem is further configured to deactivate or power off the L1-GNSS receiver along with a Radio Frequency (RF) component for the L1-GNSS receiver based on the acquisition of the generated assistance information.

5. The system according to claim 1, wherein the assistance information includes at least one of:
time and frequency information of the acquired L1-GNSS signals,
L5 acquisition information,
ephemeris information, and
clock synchronization information.

6. The system according to claim 1, wherein the modem is further configured to determine a priority for one or more GNSS service providers of a plurality of GNSS service providers; and
wherein the L1-GNSS signals are acquired from the satellites associated with the one or more GNSS service providers based on the determined priority.

7. The system according to claim 1, wherein the modem is a cellular modem.

8. The system according to claim 1, wherein the modem is NarrowBand-Internet of Things (NB-IOT) modem.

9. The system according to claim 1, wherein the modem includes Long Term Evolution for Machines (LTE-M) modem, Long Term Evolution Category 1 (LTE-Cat 1) modem, LTE-Cat 1 Bis modem, Reduced Capability (RedCap) modem, or eRedCap modem.

10. A device, comprising:
a chipset, wherein the chipset comprises a L5-Global Navigation Satellite System (L5-GNSS) receiver that supports an L5 frequency band and is communicatively coupled to an L1-GNSS receiver embedded in a modem,
wherein the L1-GNSS receiver executes an L1-acquisition operation for satellites of at least one satellite constellation to generate assistance information for the L5-GNSS receiver, and
the L5-GNSS receiver is configured to:
acquire the assistance information from the L1-GNSS receiver; and
execute an L5-acquisition and tracking operation for the satellites based on the assistance information.

11. The device according to claim 10, wherein the L5-GNSS receiver is further configured to:
determine time and frequency information and a code delay based on the execution of the L5-acquisition and tracking operation;
acquire L5-GNSS signals from the satellites; and
decode the acquired L5-GNSS signals based on the time and frequency information and the code delay to extract navigation data from the L5-GNSS signals.

12. The device according to claim 10, wherein the modem deactivates or powers off the L1-GNSS receiver along with a Radio Frequency (RF) component for the L1-GNSS receiver after the acquisition of the generated assistance information.

13. The device according to claim 10, wherein the assistance information includes at least one of:
time and frequency information associated with L1-GNSS signals,
L5 acquisition information,
ephemeris information, and
clock synchronization information.

14. The device according to claim 10, wherein the modem determines a priority for one or more GNSS service providers of a plurality of GNSS service providers; and
wherein the L1-GNSS signals are acquired from the satellites associated with the one or more GNSS service providers based on the determined priority.

15. A method, comprising:
acquiring, through an L1-Global Navigation Satellite System (L1-GNSS) receiver, L1-GNSS signals from satellites of at least one satellite constellation, wherein the L1-GNSS receiver is integrated into a modem;
executing an L1-acquisition operation based on the acquired L1-GNSS signals to generate assistance information;
acquiring, through an L5-GNSS receiver, the generated assistance information from the L1-GNSS receiver; and
executing an L5-acquisition and tracking operation for the satellites based on the assistance information.

16. The method according to claim 15, wherein the L5-GNSS receiver is an external chip that is separate from the modem and is communicatively coupled to the L1-GNSS receiver.

17. The method according to claim 15, further comprising:
determining, through the L5-GNSS receiver, time and frequency information and a code delay based on the execution of the L5-acquisition and tracking operation;
acquiring, through the L5-GNSS receiver, L5-GNSS signals from the satellites; and
decoding the acquired L5-GNSS signals based on the time and frequency information and the code delay to extract navigation data from the L5-GNSS signals.

18. The method according to claim 15, further comprising deactivating or powering off the L1-GNSS receiver along with a Radio Frequency (RF) component for the L1-GNSS receiver based on the acquisition of the generated assistance information.

19. The method according to claim 15, wherein the assistance information includes at least one of:
time and frequency information associated with the acquired L1-GNSS signals,
L5 acquisition information,
ephemeris information, and
clock synchronization information.

20. The method according to claim 15, further comprising determining a priority for one or more GNSS service providers of a plurality of GNSS service providers; and
wherein the L1-GNSS signals are acquired from the satellites associated with the one or more GNSS service providers based on the determined priority.
